(19) United States
(12) Patent Application Publication
(10) Pub. No.: US 2008/0264057 A1
(43) Pub. Date: Oct. 30, 2008

(54) Power Head Mounted on Power Crosshead

(75) Inventors: Per D. Sollie, Sheffield (GB); Lars Kjosbakken, Sheffield (GB); Sven Erik Fossum, Sheffield (GB); Eldar Onsoyen, Sheffield (GB); Sverre Johansen, Sheffield (GB)

Correspondence Address: CHRISTIAN D. ABEL, ONSAGERS AS, POSTBOKS 6963 ST. OLAVS PLASS, NORWAY, N-0130, NO

(73) Assignee: DISSENCO LIMITED, Sheffield (GB)

(21) Appl. No.: 11/912,506

(22) PCT Filed: Apr. 26, 2006
(86) PCT No.: PCT/GB2006/001516

§ 371 Date: May 22, 2008

(30) Foreign Application Priority Data
Apr. 26, 2005 (GB) 0508449.6

(51) Int. Cl. F02G 1/043

(52) U.S. Cl. 60/519

(57) ABSTRACT

A power piston (2) connected to a power crosshead (3) in conjunction with a Stirling engine is disclosed. The power piston may be mounted by means of threads (T,t) directly to the power crosshead in a Stirling engine. The assembly comprises a power piston assembly connected to a power crosshead (3) which in turn is connected to the Stirling engine crank mechanism (5).

### TECHNICAL FIELD OF THE INVENTION

The invention relates to an arrangement for a piston and a crosshead connected thereto. The invention has particular applicability to Stirling engines.

### BACKGROUND OF THE INVENTION

Stirling engines offer advantages of multi-fuel capabilities (geothermal, solar, bio-, fossil- and nuclear fuel), very low NOₓ and HC emissions when burning fossil fuels, very high total efficiency (particularly when used with CHP), and very low maintenance compared to internal combustion engines.

The principle of operation of a Stirling engine can be described with reference to FIG. 1. A displacer (a) and power piston (b) reciprocate within a cylinder with a fixed charge of working gas (e.g. air, nitrogen, helium or hydrogen). The displacer and power piston are connected to a crankshaft (c) via crossheads, connecting rods (d) and wristpins. As the displacer (a) reciprocates, it displaces the working gas (usually nitrogen or helium in production engines) through the heater head tubes (e), regenerator (f) and cooler (g) that are placed in the hot and cold portions of the engine. The displacer (a) and power piston (b) have different phase angles so that more work is put into the power piston during the expansion stroke, when most of the gas is in the hot space, than the work the piston returns to the gas a cycle later to compress cold gas back to the hot part of the engine. The net surplus of expansion work over compression work is extracted as useful work by the power piston, which in turn is transferred to the crankshaft (c) with its outgoing shaft. All external heat is supplied at the heater head (e) and rejected in the cooler (g). The regenerator (f) absorbs heat from the working gas as the gas moves from the hot end to the cold end. It returns the stored heat to the working gas when the gas is pushed from the cold end to the hot end. One can say that the regenerator acts as a “thermal dynamic sponge”.

There exist several types of Stirling engines; α-, β- and γ-type. In addition there are engines with oil lubrication and non-lubricated (or lubricated for life) engines. Next, there are engines that are hermetically sealed and ones that have a so called “atmospheric” crankcase where there is a need for a seal between the oil lubricated crankshaft assembly, displacer rod and power piston rings. This is necessary to avoid oil contamination in the hot gas circuit of the Stirling process, which would be detrimental to the function of the regenerator, cooler and heater tubes.

The traditional β-type Stirling engine mechanism is the one disclosed by Phillips, (the so called Rhombic drive). This mechanism is a great engineering achievement. However the fabrication is costly, and the mechanism requires a hermetic seal between the hot gas circuit of the Stirling process and the crankcase due to the necessary oil lubrication.

Swedish patent 467792 discloses a different β-type Stirling engine with a complicated drive mechanism assembly that converts linear motion of the displacer piston and power piston to rotational motion of the crankshaft. There are four power connecting rods and two displacer connecting rods. All connecting rods are supplied with respective linkages and rod assemblies that permit linear motion.

Swedish patent 469851 discloses another β-type Stirling engine with a complicated drive mechanism assembly that converts linear motion for the displacer piston and power piston to rotational motion of the crankshaft. The drive assembly comprises a combination of gears and connecting rods.

Japanese patent specifications JP62195443A, JP 61255255A and JP 60212660A disclose similar displacer type Stirling engines, all with various types of crosshead and linkage assemblies intended to reduce friction and prevent oil rising into the hot part of the Stirling cycle. While the engines of these disclosures may function satisfactorily, they are complex, expensive to produce, and in addition increase the total height of a Stirling engine.

In a β-type (or commonly called displacer type) engine, there is a power piston and displacer piston coaxially located within the same cylinder. In order to move the displacer piston, a displacer rod is coaxially positioned through the centre bore of the power piston. The displacer rod is fastened to the displacer crosshead.

To avoid gas leakages and potential power loss, there arises a need to seal the displacer rod from the power piston. This can be accomplished with various sealing arrangements.

Since a non-lubricated β-type engine can from time to time experience wear problems in the power piston sealing assembly there is a need for a power piston sealing assembly that is compact and easy serviceable. In order to rapidly service and/or replace these parts, it is desirable for the power piston assembly to be connected directly to the power piston crosshead.

It is an object of the present invention to provide a Stirling engine with a power piston that is connected directly to a power piston crosshead.

### DISCLOSURE OF THE INVENTION

In accordance with the present invention a Stirling engine comprises an oscillating assembly with a Displacer piston, Displacer rod, Displacer crosshead and a power piston that is connected directly to the power piston crosshead.

The invention provides an arrangement having a power piston and a displacer piston coaxially located for relative movement on a common axis, and in which the displacer piston has a rod moveable through the power piston and connected to a displacer connecting rod, and the power piston has a power connecting rod, in which the arrangement is characterised in that there is a direct connection between the power piston and the power crosshead.

It is preferred that the direct connection comprises threads between the power piston and the power crosshead, whereby relative rotational movement about the common axis can fix the power piston to the power crosshead and thence to the power connecting rod.

In this form it is further preferred that there are pins in holes to rotate power piston for installation to the power crosshead.

It is preferred that there are two power connecting rods.

In one form it is preferred that a wristpin is fitted with threads perpendicular to its centre axis, and is placed within the power crosshead.

In this form it is further preferred that the power crosshead is provided with a hole, and the hole is disposed to allow a fastener to be installed in the hole to engage and lock the wristpin.

The invention includes a Stirling engine having an arrangement according to any one of the preceding paragraphs in the Disclosure of Invention.

### BRIEF DESCRIPTION OF THE DRAWINGS

FIG. 1 shows a simplified Stirling engine.

FIG. 2 is a perspective view of an Oscillating assembly for a Stirling engine.

FIG. 3 is a perspective view of a Power Crosshead.

FIG. 4 is a cross section of the Power Crosshead.

FIG. 5 is a perspective view of a Power Piston.

FIG. 6 is a cross section of the Oscillating assembly.

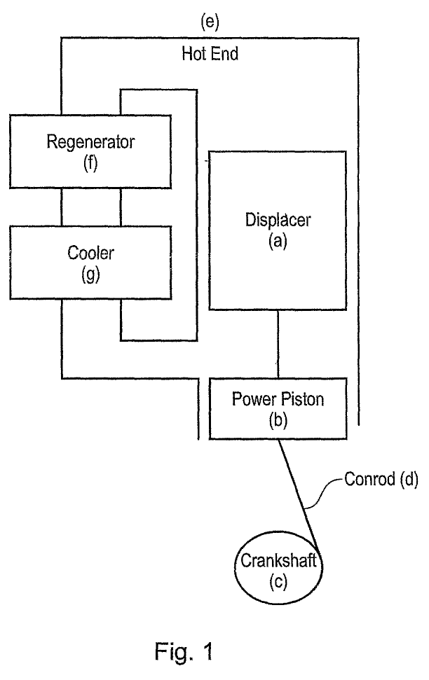

### DESCRIPTION OF A SPECIFIC EMBODIMENT OF THE INVENTION

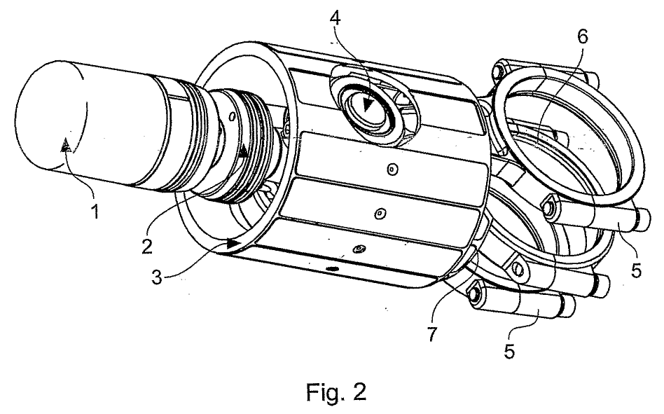

FIG. 2 is a perspective view of the Oscillating assembly within a Stirling engine. Displacer piston 1 is shown with its sealing assembly. The displacer piston 1 is fastened to a displacer rod 9 (not shown in this figure, see FIG. 6 for clarity). The displacer rod is fastened to a power crosshead wrist pin 4 with needle bearings. The power crosshead wrist pin 4 is fixed to a power crosshead 3.

Fixed to the power crosshead 3 there are two power connecting rods 5. These connecting rods 5 are split, have roller bearings and are mounted to a traditional crankshaft (not shown).

The displacer rod 9 (see FIG. 6) is concentrically placed with respect to power piston 2 and the displacer piston 1. The displacer rod 9 is fastened to the displacer crosshead 7. The displacer crosshead 7 has its own wristpin, which in turn is fixed to the displacer connecting rod 6. This connecting rod 6 is split, has a roller bearing and is mounted on the same crankshaft as the power connecting rods 5.

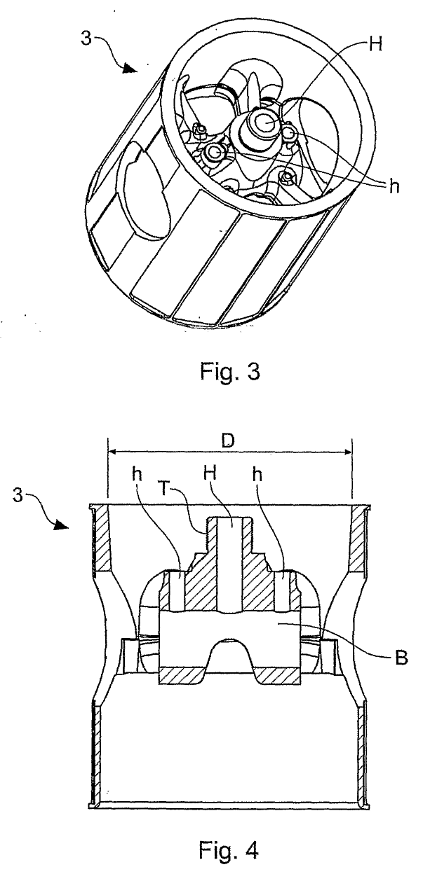

FIG. 3 is a perspective view of the power crosshead 3. As seen in FIG. 2 this crosshead 3 oscillates together with the power piston 2 and top portion of the power connecting rods 5. The power crosshead 3 is placed concentrically within a cylinder (not shown for clarity reasons). The power crosshead 3 is designed to take up all side forces that occur due to the combined oscillating and rotational motion of the power connecting rods 5. A hole H concentrically placed in the power crosshead 3 is provided to allow for the displacer rod 9 to connect to the displacer piston 1.

FIG. 4 is a cross section of the Power Crosshead 3. The hole H for allowing the displacer rod to connect to the displacer piston 1 is concentrically placed within the power crosshead 3. With reference to FIG. 2 it can be seen that the power piston 2 is fastened to the power crosshead 3. It is also clearly seen that the power piston 2 is recessed into the power crosshead 3. Going back to FIG. 4, the power crosshead 3 has an internal diameter D that is larger than the outer diameter of the power piston 2. This allows the power piston 2 to be recessed easily within the power crosshead 3, and this solution in turn reduces total height of power piston 2 and power crosshead 3.

In order to fasten the power piston 2 to the power crosshead 3, threads T are provided on the power crosshead 3. The threads T are concentrically placed on the power crosshead 3. In addition, said threads T are concentric with the displacer rod hole H.

The power crosshead 3 is also provided with a bore B that is perpendicular to the centre axis of the crosshead 3. This bore B is provided to support the wristpin 4 of the power connecting rods 5. Another hole h is provided. This hole h is perpendicular to the bore B and parallel to the displacer hole H. The hole h is provided to allow a fastener, e.g. a screw, to be installed in this hole h to secure the wristpin 4 from rotating and/or moving out of its position. Looking at FIG. 2 one screw can just be seen situated beneath the power piston 3. The wristpin 4 can be fitted with threads (perpendicular to its centre axis) to accept said screw. It is preferred (as shown in FIGS. 3 and 4) that two holes h are located on the power crosshead 3. The holes h are located on opposite sides of the concentrically placed hole H.

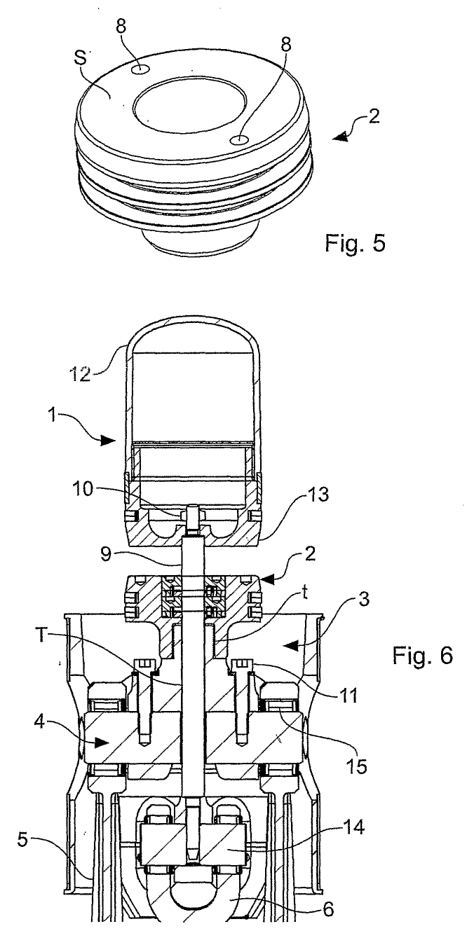

FIG. 5 is a perspective view of the power piston 2. As shown in FIG. 2, the power piston 2 is fastened to the power crosshead 3. The power piston 2 is fastened to the power crosshead 3 by means of threads T. In order to fasten the power piston 2 to the power crosshead 3, two holes 8 are provided on the top of the power piston 2. Said holes 8 are drilled perpendicularly into the top surface S of the power piston 2. These holes 8 can have a typical diameter of 5 mm and a typical depth of 3 mm. A tool with two pins having a typical diameter of 4.5 mm is used to mate within the holes 8. After inserting the tool with its pins located within the holes 8, it is easy to screw the power piston 2 onto the power crosshead 3.

The power piston may be cast integrally with the power crosshead. In this case the there will be no threads T, and the assembly holes 8 are eliminated. For assembly purposes, retaining connections 11 would be set at an angle to the axis of the rod 9. (This Alternative is not Illustrated.)

FIG. 6 is a cross section of the oscillating assembly including the displacer piston 1, displacer rod 9, power piston 2 and power crosshead 3.

In order to mount the displacer piston 1 on the displacer rod 9, the displacer piston 1 is split into two halves, namely the displacer dome 12 and the displacer base 13. The two displacer components 12 and 13 are threaded together. The displacer base 13 is fastened to the displacer rod 9 by means of a nut 10. The nut 10 is threaded to the displacer rod 9. To secure the nut 10, a typical thread locker can be used.

Two screws 11 that secure the power crosshead wristpin 4 are clearly shown. These screws 11 serve two functions. They hinder rotation of the power crosshead wristpin 4, and they avoid horizontal movement of the power crosshead wristpin 4. The power connecting rod 5 is fixed to the power crosshead wristpin 4 via needle bearings 15.

The power piston 2 is fastened and secured to the power crosshead 3 by threads t and T. Thread t is situated on the power piston 2 and thread T is situated on the power crosshead 3. As a final securing method, a traditional thread locker may be used, e.g. Loctite.

1-6. (canceled)

7. An arrangement having a power piston and a displacer piston coaxially located for relative movement on a common axis, and in which the displacer piston has a rod moveable through the power piston and connected to a displacer connecting rod, and the power piston has a power connecting rod, in which there is a direct connection between the power piston and the power crosshead, and in which the direct connection comprises threads between the power piston and the power crosshead whereby relative rotational movement about the common axis can fix the power piston to the power crosshead and thence to the power connecting rod, and in which a wristpin is fitted with threads perpendicular to its centre axis, and is placed within the power crosshead.

8. An arrangement as claimed in claim 7, in which there are pins in holes to rotate power piston for installation to the power crosshead.

9. An arrangement as claimed in claim 7, in which there are two power connecting rods.

10. An arrangement as claimed in claim 7, in which the power crosshead is provided with a hole, and the hole is disposed to allow a fastener to be installed in the hole to engage and lock the wristpin.

11. A Stirling engine having an arrangement according to claim 7.
